(19) United States
(12) Patent Application Publication
(10) Pub. No.: US 2010/0171875 A1
(43) Pub. Date: Jul. 8, 2010

(54) IMAGER CAPTURING AN IMAGE WITH A ROLLING SHUTTER

(75) Inventor: Yasuhiro YAMAMOTO, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/649,408

(22) Filed: Dec. 30, 2009

(30) Foreign Application Priority Data
Jan. 7, 2009 (JP) 2009-001963

(51) Int. Cl. H04N 5/222; G03B 15/03

(52) U.S. Cl. 348/370; 396/164; 348/E05.022

(57) ABSTRACT

An imager is provided having an image-capturing sensor, a focusing detector, a flicker detector, and a light source. The image-capturing sensor captures a subject image with a rolling shutter and outputs image data. The focusing detector determines whether a subject image is in focus of said image-capturing sensor using the output image data. The flicker detector detects a flicker in the output image data. The light source illuminates a subject while the image-capturing sensor captures a subject image. The light source emits light having a phase opposite to the phase of the flicker detected by said flicker detector.

### BACKGROUND OF THE INVENTION

1. Field of the Invention

The present invention relates to an imager that photographs a subject with a rolling shutter.

2. Description of the Related Art

Japanese Unexamined Patent Publication (KOKAI) No. 2007-329604 discloses an image sensor that comprises photodiodes aligned on a square grid and photographs with a rolling shutter, and a contrast AF that relies on the contrast of image data output by the image sensor to determine whether a lens is focused on a subject. For examples, a CMOS image sensor is used as such an image sensor.

Meanwhile, the quality of a photographed image may be degraded by a flicker caused by a light source that changes its emitting intensity with the passage of time. For example, a fluorescent light is used as such a light source. To prevent degradation of image quality, a flicker included in a photographed image is detected.

The moment of exposure is different for each photodiode in the vertical direction because a CMOS image sensor photographs with a rolling shutter. Therefore, in the case that the intensity of a light source varies with respect to time, the amount of light received by each photodiode may be different in the vertical direction. In the case where the amount of received light differs, a contrast AF may cause interference because contrast in a photographed image is not consistent.

### SUMMARY OF THE INVENTION

An object of the present invention is to provide an imager that can focus on a subject using a contrast AF procedure under flickering light conditions.

An imager is provided having an image-capturing sensor, a focusing detector, a flicker detector, and a light source. The image-capturing sensor captures a subject image with a rolling shutter and outputs image data. The focusing detector determines whether a subject image is in focus of said image-capturing sensor using the output image data. The flicker detector detects a flicker in the output image data. The light source illuminates a subject while said image-capturing sensor captures a subject image. The light source emits light having a phase opposite to the phase of the flicker detected by said flicker detector.

### BRIEF DESCRIPTION OF THE DRAWINGS

The objects and advantages of the present invention will be better understood from the following description, with reference to the accompanying drawings in which:

FIG. 1 is a perspective view of the back of a digital camera having the imager according to the embodiment of the present invention;

FIG. 2 is a block diagram of the digital camera;

FIG. 3 is an elevated front view of an imaging area;

FIG. 4 is a circuit diagram of an AF auxiliary light source and an LED driver;

FIG. 5 is a circuit diagram of part of a circuit provided in a CMOS image sensor;

FIG. 6 is a timing diagram that shows the timing of retrieving an analog image signal from the CMOS image sensor; and

FIG. 7 is a flowchart of a flicker reduction procedure.

### DESCRIPTION OF THE PREFERRED EMBODIMENTS

The present invention is described below with reference to the embodiment shown in the drawings.

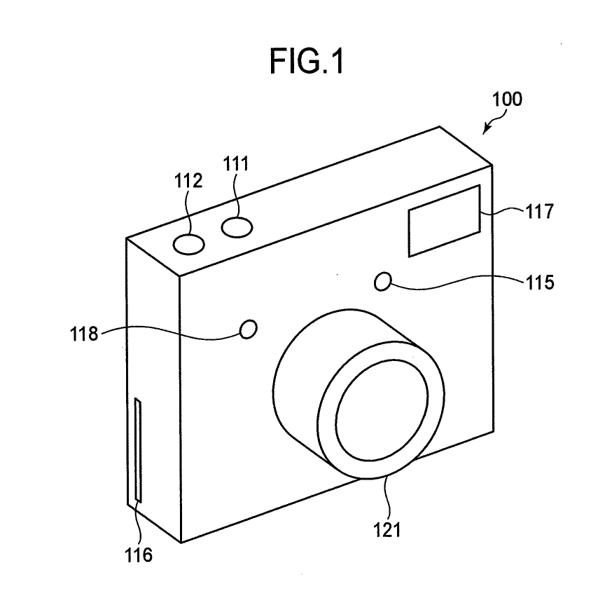

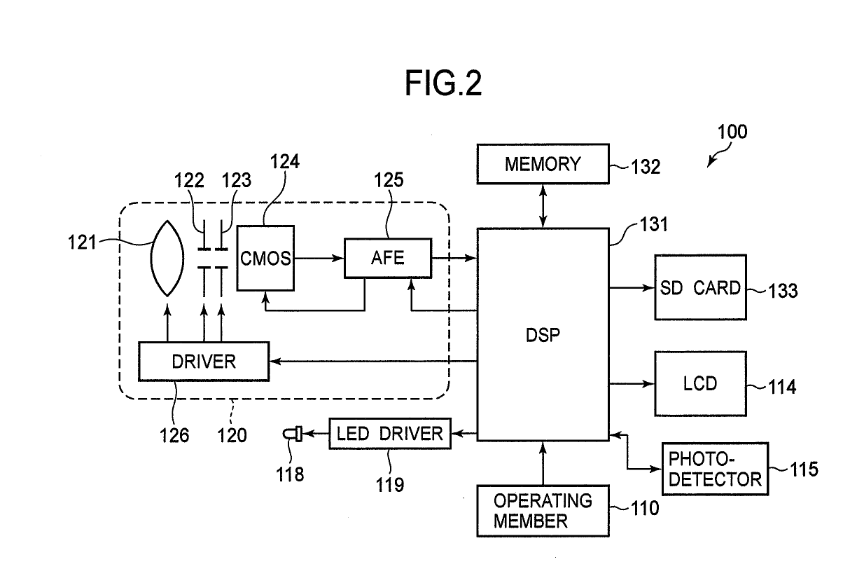

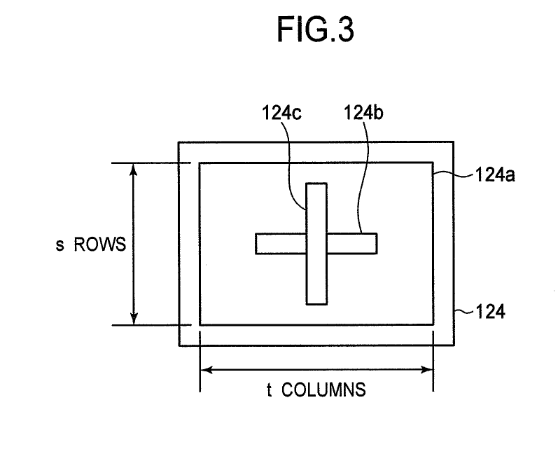

A digital camera 100, which is an imager according to the embodiment, is described with reference to FIGS. 1 to 3. The digital camera 100 is, for example, a compact camera.

The digital camera 100 mainly comprises a DSP 131 that controls the digital camera 100, an operating part 110 that is used to operate the digital camera 100, a photographing member 120 that converts a subject image to a digital signal, a memory 132 that stores data sent from the DSP 131, an SD card 133 that stores photographed images, an LCD 114 that displays photographing conditions and photographed images, a photo detector 115, a strobe lamp 117, and an AF auxiliary light source 118.

The photographing member 120 mainly comprises a photographing lens 121, a shutter 123, an aperture 122, a CMOS image sensor 124, an AFE (Analog Front End) 125, and a driver 126 that drives the photographing Lens 121, the shutter 123, and the aperture 122.

The photographing lens 121 comprises a focusing optical system that brings a subject into focus. The driver 126 controls the position of the focusing optical system so that focus of the photographing lens 121 is adjusted and a subject image reaches the CMOS image sensor 124.

The CMOS image sensor 124 has an imaging area 124a that is used in the capture of an image. Focus of the photographing lens 121 is adjusted to form a subject image on an imaging area 124a of the CMOS image sensor 124.

The aperture 122 controls a beam of light running from the photographing lens 121 to the CMOS image sensor 124 so as to control the amount of light a subject image forms on the imaging area. The shutter 123 controls the period of time in which a subject image is exposed to the imaging area. The CMOS image sensor 124 converts a subject image that is incident on the imaging area to an analog image signal and sends it to the AFE 125. The AFE 125 adjusts the gain and other aspects of the analog image signal, converts it to a digital image signal, and then sends it to the DSP 131. The driver 126 controls the position of the focusing system, size of the aperture 122, and shutter speed according to signals received from the DSP 131.

Before photographing, the DSP 131 measures the amount of light that is incident on a subject, this information is included in the digital image signal. The DSP 131 calculates an exposure value based on the amount of light, and calculates a shutter speed and an aperture value, i.e. an F-number, using the exposure value. Afterward, it sends the shutter speed and F-number to the driver 126. Moreover, it determines the appropriate position of the focusing system based on the received digital image signal, and sends the coordinates of the appropriate position of the focusing system to the driver 126.

The DSP 131 processes the image of a digital image signal and detects the color temperature, cycle, and phase of the light source. The white balance of a photographed image is adjusted using the color temperature of the light source.

After the DSP 131 receives the digital image signal from the AFE 125, it adjusts the white balance of the image before sending the adjusted image as a through image to the LCD 114. The through image consists of multiple still images, but it is perceived as a moving image by a user.

During photographing, the DSP 131 processes the image of a digital image signal and creates a photographic image. The photographic image is stored in the SD card 133 and displayed on the LCD 114. The memory 132 is used as a working memory and stores data temporarily when the DSP 131 executes these calculations and carries out image processing.

The plurality of photodiodes, i.e., the plurality of pixels, is organized in a matrix of s rows and t columns in the imaging area 124a. The DSP 131 provides a virtual horizontal AF area 124b and a virtual vertical AF area 124c in the imaging area 124a of the CMOS image sensor 124. The horizontal AF area 124b is provided at the center of the imaging area 124a in the vertical direction of the imaging area 124a, and has a rectangular shape extending in the longitudinal direction, i.e., the horizontal direction of the CMOS image sensor 124. The horizontal AF area 124b comprises multiple pixels forming either a single row or a plurality of rows. The vertical AF area 124c is provided at the center of the imaging area 124a in the longitudinal, i.e., horizontal direction of the imaging area 124a, and has a rectangular shape extending in the vertical direction of the CMOS image sensor 124. The vertical AF area 124c comprises multiple pixels forming either a single row or a plurality of rows. The horizontal AF area 124b orthogonally crosses the vertical AF area 124c, so that their centers overlap. The centers of imaging area 124, the horizontal AF area 124b, and the vertical AF area 124c all overlap with each other. The DSP 131 executes a contrast AF procedure that moves the focusing optical system to an in-focus position.

In the contrast AF procedure, contrast values C are calculated for all pixels located in both of the horizontal AF area 124b and vertical AF area 124c, and the in-focus position of the focusing optical system is adjusted to the position corresponding to the highest average value of the calculated contrast values.

The contrast value C is calculated based on a G signal (a green signal) value output by the CMOS image sensor 124 for a color image, and based on a luminance value output by the CMOS image sensor 124 for a monochrome image. More specifically, the following formula is used for the calculation of the contrast value Cn of pixel n using luminance P(n):

Cn=−P(n−1)+2·P(n)−P(n+1)

The LCD 114 has a rectangular screen with an aspect ratio of 3 to 4, which is the same as a photographic image. The LCD 114 is provided on the central part of the back side of the digital camera 100, such that its longitudinal direction extends parallel to the longitudinal (left to right) direction of the digital camera 100. Images captured through the photographing lens 121, photographed images, through images, and a variety of configuration data for the digital camera can all be displayed on the LCD 114. The through image is sent from the DSP 131.

The operating member 110 has a main power button 111 and a release button 112.

The main power button 111 is a push switch projecting from the top of the digital camera 100. The digital camera 100 is powered when a user depresses the main power button 111. The digital camera 100 is powered off when a user depresses the main power button 111 while the digital camera 110 is powered.

The release button 112 is a two-stage push switch that is provided on the top surface of the digital camera 100. The digital camera 100 executes photometry, distance surveying and focusing when a user depresses the release button 112 only halfway. Otherwise, when the release button 112 is fully depressed, the digital camera 100 captures an image.

The photo detector 115 is provided on the digital camera 100 in close proximity to the photographing lens 121, and detects color temperature, cycle, and phase of ambient light surrounding the digital camera 100. The detected value is sent to the DSP 131.

The strobe lamp 117 is provided on the front surface of the digital camera 100 in close proximity to the photographing lens 121, and is used as an auxiliary light source during photographing.

The AF auxiliary light source 118 comprises a white LED, and is provided on the front surface of the digital camera 100 in close proximity to the photographing lens 121. It is used as the auxiliary light source during the contrast AF procedure. The DSP 131 comprises the D/A converter 134. The D/A converter 134 is connected to the LED driver 119. The AF auxiliary light source 118 is driven by the LED driver 119.

The DSP 131 controls when the D/A converter 134 signals the amp 119a to have the AF auxiliary light source 118 emit light. The signal is amplified by the amp 119a, and applied to the base of the transistor 119b. Upon receiving the signal, the transistor 119b causes the cathode of the AF auxiliary light source 118 to ground through the resistor 119c. The anode of the AF auxiliary light source 118 is connected to the power source 119d. Therefore, the AF auxiliary light source 118 emits white light.

In the contrast AF procedure, in the case that the DSP 131 cannot acquire a contrast value C because of insufficient light, the DSP 131 signals the LED driver 119 to control the AF auxiliary light source 118 to emit light. Therefore, the photographing lens 121 can be focused on a subject by executing the contrast AF procedure under limited light conditions.

The SD card 133 is detachably stored in a card slot 116 that is provided on the side of the digital camera 100. A user can access the SD card 133 and replace it from the outside of the digital camera 100.

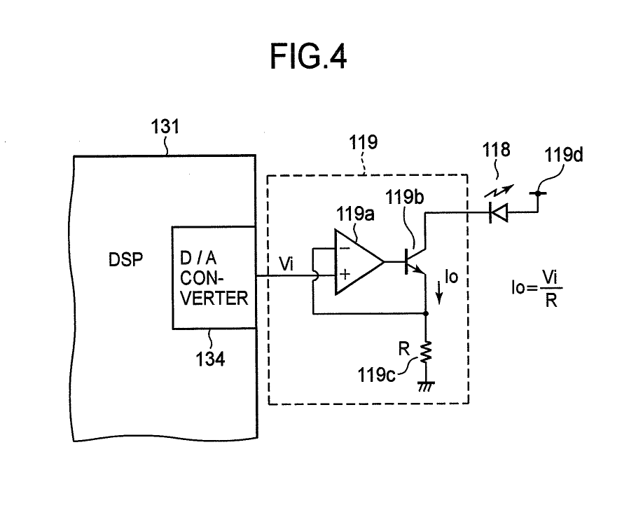

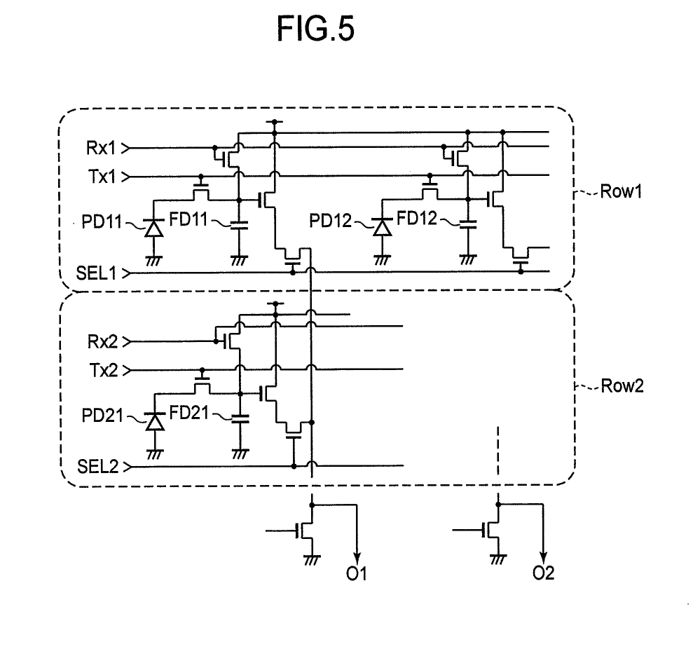

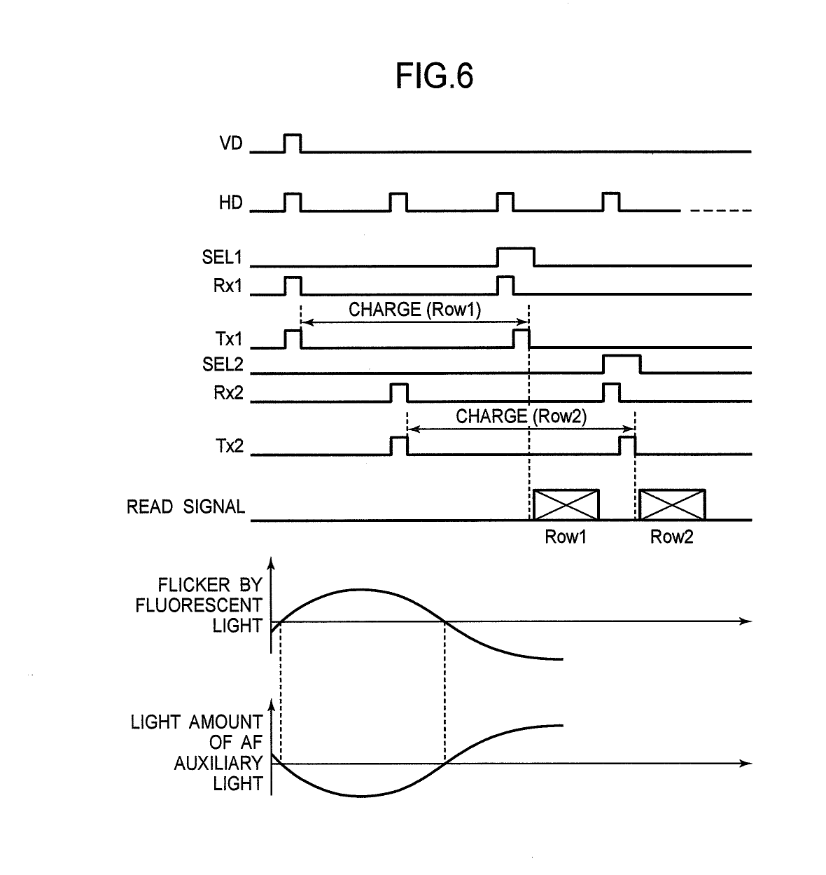

The procedure of reading analog image signals from the CMOS imaging sensor 124 using the rolling shutter is described below with reference to FIGS. 5 and 6. The CMOS imaging sensor 124 comprises the circuit illustrated in FIG. 4.

The CMOS imaging sensor 124 comprises a time-signal generator (not illustrated). All of the pixels provided in the CMOS image sensor 124 are synchronized with time signals generated by the time-signal generator.

The pixels provided in the CMOS image sensor 124 have a photodiode PD, a junction capacitance FD, and a plurality of field-effect transistors (FET). The photodiode PD1i provided in the first row is connected to a first reset signal line Rx1 with an FET, a first transfer signal line Tx1, and a first select signal line SEL1. Similarly, the photodiode PDni provided in the nth row is connected to an n reset signal line Rxn with an FET, an n transfer signal line Txn, and an nth select signal line SELn. The photodiodes PDi1 provided in the first row are connected to a first output line O1 with the FETs. Similarly, the t pieces of the photodiodes PDni provided in the nth row are connected to an nth output line On with the FETs.

When the pixel signal is read from the CMOS image sensor 124, the voltage of the vertical synchronization signal line VD, the horizontal synchronization signal HD, the first reset signal line Rx1, and the first transfer signal line Tx1 are set to High at the first time signal. This procedure zeroes out both the electric charge in the first photodiode PD11 and the junction capacitance FD11. Next, the voltage of the vertical synchronization signal line VD, the horizontal synchronization signal HD, the first reset signal line Rx1, and the first transfer signal line Tx1 are set to Low. After that, when the CMOS imaging sensor 124 receives light, an electric charge begins being stored in the first photodiode PD11 according to the amount of light received. This operation is carried out for all photodiodes PD1n provided in the first row.

At the next time signal, the voltage of the horizontal synchronization signal HD, the second reset signal line Rx2, and the second transfer signal line Tx2 are set to High. This procedure zeroes out both the electric charge in the second photodiode PD21 and the junction capacitance FD21. Next, the voltage of the vertical synchronization signal line VD, the horizontal synchronization signal HD, the second reset signal line Rx2, and the second transfer signal line Tx2 are set to Low. After that, when the CMOS imaging sensor 124 receives light, an electric charge begins being stored in the second photodiode PD21 according to the amount of light received. This operation is carried out for all photodiodes PD2n provided in the second row. All of the photodiodes PDnn begin storing electric charges by executing this procedure for all rows.

At the next time signal, the voltage of the horizontal synchronization signal HD, the selecting signal SEL1 and the first reset signal line Rx1 are set to High, and the reset element is read. After a predetermined duration, the voltage of the first reset signal line Rx1 is set to Low, and the voltage of the transfer signal line Tx1 is set to High, so that the signal element can be read. The differential between the signal element and the reset element is detected using the CDS circuit (not shown) provided in the CMOS image sensor 124, so that the preparation for reading an electric charge from the first photodiode PD11 is completed. This operation is simultaneously carried out for all of the photodiodes PD1n provided in the first row.

At the next time signal, the voltage of the horizontal synchronization signal HD, the selecting signal SEL2 and the second reset signal line Rx2 are set to High, and the reset element is read. After a predetermined duration, the voltage of the second reset signal line Rx2 is set to Low, and the voltage of the transfer signal line Tx2 is set to High, so that the signal element can be read. The differential between the signal element and the reset element is detected using the CDS circuit (not shown) provided in the CMOS image sensor 124, so that the preparation for reading an electric charge from the second photodiode PD21 is completed. This operation is simultaneously carried out for all of the photodiodes PD2n provided in the second row.

The pixel signals are output from all of the photodiodes PDnn by executing these procedures for all rows. The time difference between storing the electric charges in the photodiodes PD that belong to the adjoining lines is 1HD period. The length of 1HD period extends from the moment of the High voltage of the horizontal synchronization signal HD to the High voltage of the next signal.

In the case that a fluorescent light source with emission intensity that varies with respect to time is used as a light source, the intensity of light emitted by the fluorescent light source varies until all photodiodes in the CMOS imaging sensor 124 finish outputting the electric charge. That is, in the case that intensity of the light reflected by a subject varies with respect to time, the intensity of the light received by the CMOS imaging sensor 124 varies until all photodiodes in the CMOS imaging sensor 124 finish outputting the electric charge. Therefore, the amount of light stored in each photodiode PD may be different in the vertical direction. In the case that the amount of light received is different, it may interfere with a contrast AF procedure and destabilize the contrast of a photographic image. To prevent this from occurring, the flicker reduction procedure, which is described hereinafter, is carried out.

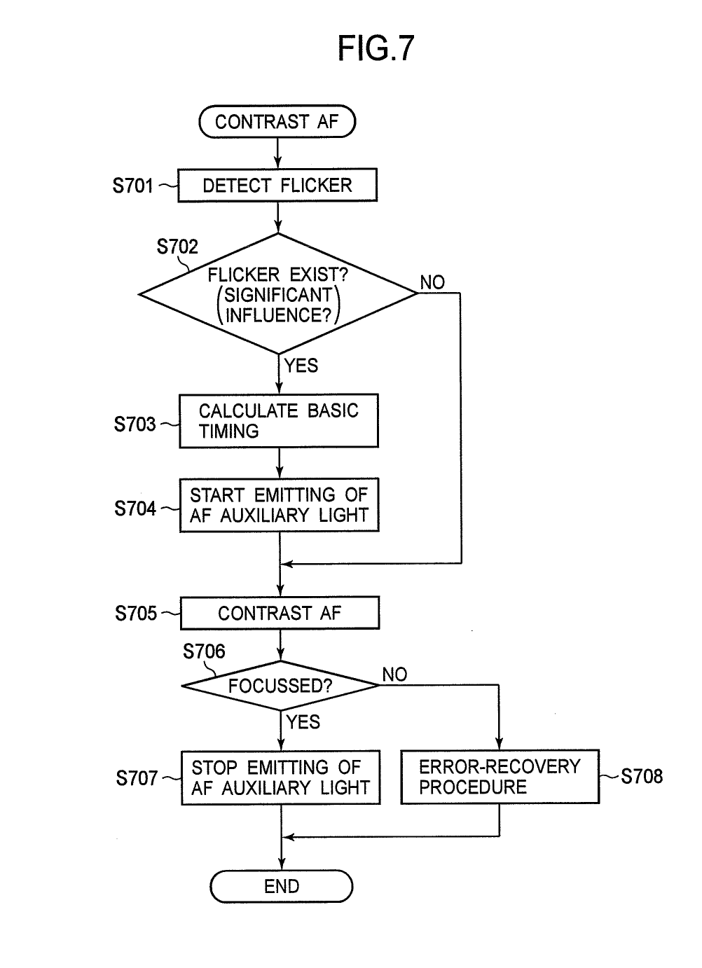

The flicker reduction procedure is described below with reference to FIGS. 6 and 7. The flicker reduction procedure is carried out when the release button 112 is depressed halfway.

In Step S701, the DSP 131 tries to detect a flicker included in the digital image signal. In Step S702, it is determined whether or not a flicker is included in a digital image signal. In the case when a flicker is included, the procedure proceeds to Step S703 because an amount of light received by the photodiodes PD provided in each row may differ in the vertical direction. In the case flicker is not included, the procedure proceeds to Step S705.

In Step S703, the timing of light emitted by the AF auxiliary light source 118 is calculated using the cycle and phase of a flicker. Both the cycle and phase of a flicker are detected by the DSP 131 using the digital image signal. The timing of light emitted by the AF auxiliary light source 118 is calculated so that its cycle is the same as the cycle of a flicker, and its phase is inverted to the phase of the flicker.

In Step S704, the DSP 131 sends a signal to the LED driver 119 that makes the AF auxiliary light source 118 blink during the time of emission calculated in Step S703. The light amount of the AF auxiliary light source 118 changes stepwise, continuously, or such as that illustrated in FIG. 6.

In Step S705, the contrast AF procedure is carried out using a contrast value C obtained from the pixels provided in the horizontal AF area 124b and the vertical AF area 124c.

In Step S706, a contrast value C is measured to determine whether or not a subject is in focus of the photographing lens 121. In the case when the subject is in focus, the procedure proceeds to Step S707; otherwise, the procedure proceeds to Step S708.

In Step S707, the DSP 131 stops sending a signal to the LED driver 119. Afterward, the procedure ends.

In Step S708, an error-recovery procedure is carried out. Afterward, the procedure ends.

According to these preceding steps, the contrast AF procedure can be executed without interference caused by a flicker.

According to the embodiment, the imager 100 can focus on a subject using a contrast AF procedure even if it is under the influence of a flicker.

Note that, in Step S702, it may be determined whether or not the magnitude of a flicker in the digital image signal is greater than a predetermined value, yet whether or not a flicker is included in the digital image signal may not be determined. In this case, the procedure proceeds to Step S703 when the magnitude of a flicker is greater than a predetermined value.

In Step S702, it may be determined whether or not a storage period per row of an electric charge, i.e., a period from the moment of the n transfer signal line Txn being Low to its next value is shorter than a predetermined threshold value or not. The predetermined threshold value is, for example, 50 ms in order to include enough blinking cycles for a fluorescent light with a blinking cycle of 50 Hz. The predetermined threshold value that includes enough blinking cycles is a period in which a fluorescent light blinks at least one time. In the case that the storage period of an electric charge is shorter than such threshold value, the amount of light received by the photodiodes PD provided in each row may differ. Therefore, such a threshold value is used. In the case that a period for storing an electric charge per a row is shorter than a predetermined threshold value, the procedure proceeds to Step S703.

In Step S702, both the cycle and phase of a flicker may be detected by the photo detector 115, whereas they may not be detected by the DSP 131.

In Step S740, the amount of light emitted by the AF auxiliary light source 118 may be controlled according to a distance from the imager 100 to a subject.

In Step S705, the contrast AF procedure may be executed using a contrast value C that is calculated from all of the pixels in the imaging area 124a, while it may not be calculated from the pixels in the horizontal AF area 124b and the vertical AF area 124c.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2009-001963 (filed on Jan. 7, 2009), which is expressly incorporated herein, by reference, in its entirety.

1. An imager comprising:
an image-capturing sensor that captures a subject image with a rolling shutter and outputs image data;
a focusing detector that determines whether a subject image is in focus of said image-capturing sensor using the output image data;
a flicker detector that detects a flicker in the output image data; and
a light source that illuminates a subject while said image-capturing sensor captures a subject image, said light source emitting light having a phase opposite to the phase of the flicker detected by said flicker detector.

2. The imager according to claim 1, wherein said light source determines emitting intensity according to the distance to a subject.

3. The imager according to claim 1, wherein said focusing detector determines whether a subject image is in focus of said image-capturing sensor using a contrast auto focus device.

4. The imager according to claim 1, wherein said light source has an LED and a driver that controls the LED to emit light periodically.

5. The imager according to claim 1, further comprising a light source detector that detects a type of a light source illuminating a subject, and wherein said flicker detector detects flicker when the detected type of a light source corresponds to a certain type.

6. The imager according to claim 1, further comprising a light cycle detector that detects a cycle of light that illuminates a subject, and wherein said flicker detector detects flicker when the detected light cycle corresponds to a certain type.

7. The imager according to claim 6, wherein said flicker detector controls said light source so as to emit light that has a phase opposite to the phase of the flicker detected by said flicker detector, in the case that the charge storage time per one row of said image-capturing sensor is shorter than the threshold time that is determined according to the light cycle detected by said light cycle detector.
